(19) United States
(12) Patent Application Publication
(10) Pub. No.: US 2004/0040267 A1
(43) Pub. Date: Mar. 4, 2004

(54) Hand grip for assisting a beginner ride in rein control

(76) Inventor: Yann Dubourg, Roaillan (FR)

Correspondence Address: YOUNG & THOMPSON, 745 SOUTH 23RD STREET 2ND FLOOR, ARLINGTON, VA, 22202

(21) Appl. No.: 10/450,378

(22) PCT Filed: Dec. 12, 2001
(86) PCT No.: PCT/FR01/03968

(30) Foreign Application Priority Data
Dec. 13, 2000 (FR) 00 16198

(51) Int. Cl. B68B 1/00

(52) U.S. Cl. 54/36

(57) ABSTRACT

The invention concerns a device, designed to be used in horse riding, consisting of hand grips (1) linked to a collar (5) enclosing a horse's neck. The invention is characterised, in that the hand grips (1) are compact and do not hinder the use of reins, the element linking the hand grip (1) to the collar (5) partly consists of an elastic (3) and the collar (5) is fixed midway on the neck so as to allow the hands translational and lateral freedom. The device enables to avoid faulty handling on the experienced rider's part, enables the beginner to find the right balance and controls the horse's mouth.

The present invention relates to a device, adapted to be used in horseback riding, comprising handgrips connected to a collar passing about the neck of a horse, characterized in that the handgrips are of reduced size and do not impede the use of the reins, that the attachment between the handgrip and the collar is partially comprised by elastic, and that the securement to the collar takes place at mid-neck so as to permit the independence of the hand both in translation and laterally.

The device permits avoiding clumsiness of the hands of the experienced rider, assists the beginning rider in his riding lessons, and protects the mouth of the horse.

The present invention relates to a device seeking to facilitate the practice of horseback riding by acting on the securement and independence of the hands.

The independence of the aids (the seat, the legs, the hands) is an essential part of horseback riding. The use of a saddle seeks to facilitate the mastery of the seat, the stirrups facilitating the mastery and hence the independence of the legs.

Conventionally, to assist the control of his hands, the rider has two methods: to grasp the mane of the horse, or to grasp a collar passed about the horse's neck. These two empirical methods are contradictory: they improve the securement but prevent the necessary independence to direct the horse.

The device which is the object of the invention is a handgrip of a length equivalent to the width of three fingers (ring finger, middle finger, index finger) connected to a collar passed about the neck of the horse. This handgrip has the necessary rigidity to support a substantial pressure (as a function of the force and weight of the rider) and the slenderness necessary so as not to impede the use of the reins. The fingers enclose this handgrip and the reins. The handgrip is in direct contact with the fingers at the level of the third phalange, the reins are superposed on the handgrip by passing as taught in riding school, between the ring finger and the little finger and the index finger and the thumb. The handgrip is fixed to the collar thanks to a first fixed attachment on the handgrip between the ring finger and the middle finger. This securement permits the use of the handgrip without impeding the use of the reins. This first attachment is connected to an elastic which is itself connected to the collar via a second adjustable attachment fixed on the collar at mid-neck. The elastic permits an action in translation. The securement at mid-neck and the length of the straps and the elastic permit a lateral action of the hand. This mid-neck securement can be adjustable so as to adapt to the size of the horse and the rider. A system of two clips is fixed on the collar several centimeters below the level of the withers to permit the rider to fix the handgrips. These clips hold the handgrips in such a position as to permit the rider to grasp the handgrips rapidly with a simple movement. A snap clasp system with rapid attachment is stitched on the collar about three centimeters below the securement clips. This snap clasp permits rapidly and directly securing the attachment of the handgrip to the collar. By using this securement means, the rider can use the handgrips secured to the collar. The handgrips can comprise distinguishing means corresponding to the pennants near the obstacles: red for the right handgrip, white for the left handgrip. The collar is adjustable and can be fixed to the straps and to the saddle to ensure its support.

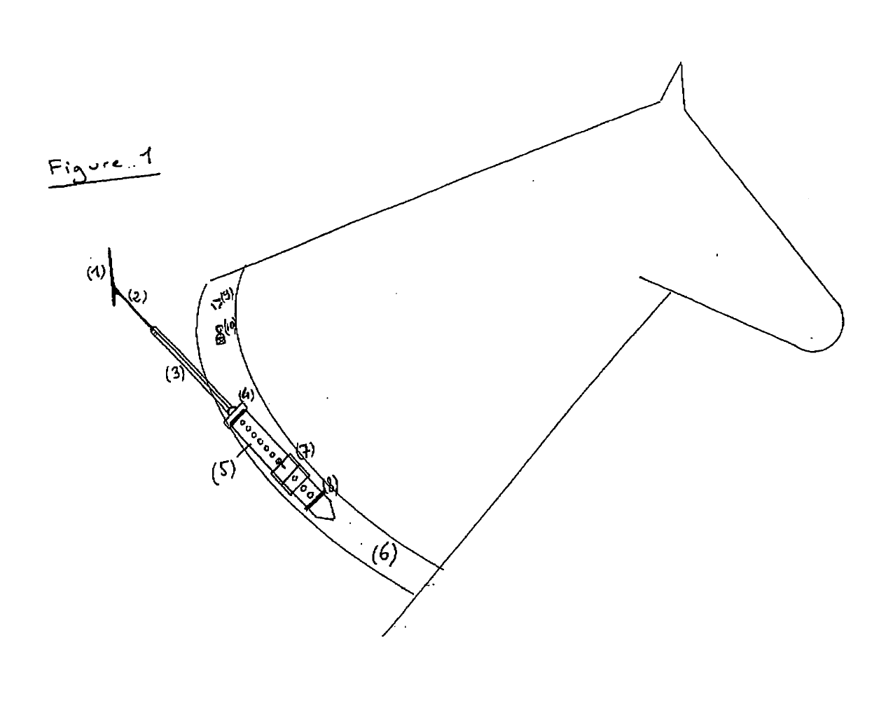

Referring to the accompanying FIG. 1, which is a schematic view, there will now be described the particular embodiments:

The handgrip (1) can have a length equivalent to the width of three fingers.

The handgrip (1) can be made of steel and covered with a piece of leather.

The attachment of the handgrip (2) can, thanks to a system of stitching, be the prolongation of the leather piece having served to cover the handgrip (1).

This attachment (2) can have a length of 3 cm.

A ring can be stitched at the end of the attachment of the handgrip.

The elastic (3) can be fixed to the ring of the handgrip with the help of a snap clasp.

The elastic (3) can have a length of 6 cm.

The elastic (3) can be provided at its other end with an eyelet (4) which permits passing the securement strap to the collar (5).

The attachment between the elastic and the collar (6) can be a leather strap (5) of 40 cm stitched to the collar about 20 cm below the level of the withers, adjustable thanks to the eyelet of the elastic (4) through which it passes and a conventional buckle (7) stitched on the collar.

Loops (8) can be provided on the collar so as to receive the extra length of the adjustment leather strap (5).

Two clip securement supports for the handgrips can be stitched on the collar 15 cm above the securement of the securement strap (9).

Snap clasps (10) with rapid attachment can be stitched on the collar about 3 cm below the clip securement supports (9).

The reduced size of the handgrip is such that it permits the use of the reins without particular impairment. The resistance of this handgrip and of the connection to the collar permits the rider to use this handgrip to maintain his position and to keep the hands in place under all circumstances. The use of an elastic permits the rider to have an action on the mouth of his horse, which action is voluntarily limited thanks to the resistance of the elastic.

According to an unillustrated modification, the handgrips can be fixed to a breast harness instead of and in place of the collar.

By way of non-limiting example, the handgrip will have a length of 4 cm, a width of 1 cm and a thickness of 0.5 cm. The leather strap connected to the handgrip will have a length of 3 cm, the elastic length of 6 cm and the leather strap connected to the collar a length varying from 2 to 20 cm according to the adjustment.

All equitation practices are subject to benefit from this invention.

A long adjustment of the device permits assisting the rider in seated position, whether he is a beginning or an experienced rider.

A short adjustment permits assisting a rider in the so-called suspension position, more particularly during jumping practice.

The use of the handgrips fixed on rapid attachments of the collar permits a rider rapidly to obtain a use of the handgrips near the use of a conventional collar with the comfort provided by the handgrip.

The device permits avoiding manual mistakes of the experienced rider, assists the beginning rider in training and protects the mouth of the horse.

1. Device to be used particularly in horseback riding so as to assist the rider in training and the independence of the hands characterized in that it comprises two handgrips connected by straps and elastics to a collar passed about the neck of the horse.

2. Device according to claim 1, characterized in that the handgrip is of a length equivalent to the width of the three following fingers: the index finger, the middle finger, the ring finger; of a width of about one centimeter and of a small thickness.

3. Device according to claims 1 and 2, characterized in that a slender attachment adapted to pass between the fingers is fixed on the handgrip.

4. Device according to claim 3 characterized in that the attachment of the handgrip is connected to an elastic.

5. (Amended) Device according to claim 1characterized in that the two adjustable attachments are fixed to the collar at a level located about mid-neck.

6. Device according to claim 5 characterized in that the level of securement of the adjustable attachment on the collar can itself be also adjustable over a length of about twenty centimeters.

7. (Amended) Device according to claim 5 characterized in that the two attachments fixed to the collar permit adjustment of the length of the securement between the collar and the elastic by way of an eyelet fixed on the elastic and a buckle fixed on the collar.

8. (Amended) Device according to claim 1 characterized in that a system of clips fixed on the collar permits a securement and rapid grasping of the handgrips on the collar.

9. (Amended) Device according to claim 1 characterized in that snap clasps with rapid attachments are stitched on the collar about three centimeters below the securement clips.

10. (Amended) Device according to claim 1 characterized in that the set of two handgrips comprises distinguishing means corresponding to the pennants associated with obstacles: red for the right handgrip, white for the left handgrip.
